(19) United States
(12) Patent Application Publication
(10) Pub. No.: US 2008/0013928 A1
(43) Pub. Date: Jan. 17, 2008

(54) Method and apparatus for generating a content presentation signal

(75) Inventor: Alan David Macduff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N. V., Eindhoven (NL)

(21) Appl. No.: 10/549,540

(22) PCT Filed: Mar. 18, 2004
(86) PCT No.: PCT/IB04/50282

§ 371 Date: May 30, 2006

(30) Foreign Application Priority Data
Mar. 20, 2003 (NL) 1022978

(51) Int. Cl. G11B 27/10; H04N 5/00

(52) U.S. Cl. 386/125; 386/46

(57) ABSTRACT

Disclosed is a system for generating a content presentation signal such as an audiovisual signal. A content source (203), such as a Digital Versatile Disc (DVD) comprises a plurality of content data streams (301, 303, 305, 307). The content source (203) further comprises a virtual content stream (309) comprising content data pointers to the content data of the plurality of content data streams (301, 303, 305, 307). An apparatus (200) comprises an interface (201) for the content source and a virtual content stream processor (205) which retrieves the virtual content stream (309) through the interface (201) and stores it in memory (207). A data pointer processor (209) selects data pointers in response to a presentation criterion, such as a desired quality or data bandwidth of the interface (201). A presentation signal processor (211) generates a content presentation signal by retrieving the content data of the plurality of content data streams pointed to by the content data pointers.

The invention relates to a method and apparatus for generating a content presentation signal from a content source comprising a plurality of content types.

In recent years, content such as films, TV programmes, music etc have increasingly been distributed in different ways and by different means. Especially, the increased use of digital signals to represent content has resulted in an increased number of possible distribution channels and means for storing content signals. Furthermore, digital representation has allowed for an increasing flexibility in the processing and presentation of content signals as well as an increased storage capacity of distribution media. This has resulted in an increasing number of different content being provided on the same storage media.

For example, Digital Versatile Discs (DVDs) are now typically produced comprising a main video signal, a plurality of different subtitles and a plurality of different associated audio tracks, such as different languages or additional comments by the cast or director. All of these different content sub-signals are stored by interleaving of the different data associated with the different content sub-signals in a single data stream on the DVD media. Specifically, the data stream of audio visual data is built up of packets with a header with synchronisation data and a payload comprising video signal data, audio signal data or other data. When replaying a DVD disc, the DVD player reads the data stream and selects the data associated with the selected content sub-signals and processes this data for presentation.

However, this approach requires that the data rate of the signal being read from the DVD is sufficient to support the combined data rate of all the stored content sub-signals. As the reading data rate of a DVD drive is limited, this provides a significant limitation in the available data rate for the individual content sub-signals. Furthermore, in order to ensure that the DVD can be used in all intended DVD drives, it is necessary to restrict the data rate of the data stream to the reading capability of the slowest DVD drives. This provides a significant restriction in the data rate and impedes the full exploitation of advances in the technology such as improvements in the reading rate of the DVD drives or the advent of new high rate content signals.

Hence, an improved method of generating content signals from a content source would be advantageous and in particular a system that allows for increased flexibility, performance and adaptability and suitability for new content signals and advances in the technology would be advantageous.

Accordingly, the Invention seeks to mitigate, alleviate or eliminate one or more of the above mentioned disadvantages singly or in any combination.

According to a first aspect of the invention, there is provided an apparatus for generating a content presentation signal comprising: an interface for a content source, the content source comprising a plurality of content data streams comprising content data associated with a content signal and a virtual content stream comprising content data pointers to the content data of the plurality of content data streams; means for retrieving the virtual content stream through the interface; means for retrieving content data pointers from the virtual content stream in response to a presentation criterion; and means for generating the content presentation signal from content data of the plurality of content data streams associated with the retrieved content data pointers.

The plurality of content data may be associated with a plurality of content signals. The content signal may be a combined content signal comprising sub-content signals e.g. one or more video signals, one or more audio signals and/or one or more data signals. The retrieved content pointers may be all or a subset of the content pointers. Specifically, the means for retrieving the virtual content stream through the interface and the means for retrieving content data pointers from the virtual content stream in response to a presentation criterion may be combined such that only a desired subset of data pointers of the virtual content stream are retrieved through the interface. The interface may for example be a DVD drive and the content source may be a DVD disc.

The invention allows for an apparatus to access data streams in accordance with pointers retrieved from a different data stream. The apparatus thus allows for a low data rate data stream to be retrieved in response to which selected data streams can be identified and accessed. The invention accordingly allows for a parallel and possibly independent storage of data streams in the content source and does not require a serial interleaving of different content data within a single content stream.

The apparatus need only to access the content data streams required for generation of the content presentation signal thus allowing for a significantly reduced data rate or additionally or alternatively, increased data rate data streams to be retrieved thereby allowing for higher data rates of individual content sub-signals. Specifically, the apparatus may be operable to retrieve data rates higher than the minimum data rate associated with the content source, such as a minimum rate that would allow the content source to be used with all of a group of content presentation apparatuses, and may thus be able to access additional data which for example may provide additional information to a user or a content signal of increased quality.

Furthermore, the apparatus allows for a scalable arrangement of the content source wherein different data streams suited for different performance and capabilities of different play back equipment may be stored. Accordingly, the apparatus allows for content sources that are not restricted by a minimum requirement but may comprise different possibilities for different equipment. Specifically, the invention allows for content sources which exploit technological advances yet are backwards compatible.

According to a feature of the invention, the virtual content stream comprises synchronisation information related to the content data associated with the content data pointers, and the means for generating the content presentation signal is operable to generate the content presentation signal in response to the synchronisation information.

The synchronisation information may comprise in a grouping of pointers having associated synchronisation such as grouping of data pointers pointing to simultaneous data of the data streams with respect to the content presentation signal. This allows for a simple and efficient mechanism of synchronising data of different data streams in order to create a content presentation signal from a plurality of data streams.

According to a different feature of the invention, the means for generating is operable to generate the content presentation signal from a subset of content data streams. This allows for a very flexible generation of the content presentation signal wherein only the required and/or desired content data streams are used.

According to a different feature of the invention, the means for generating is operable to generate the content presentation signal as an interleaved content data stream by interleaving the content data of the plurality of content data streams associated with the retrieved content data pointers. This allows for a content presentation signal to be generated which comprises the required data in a single data stream. A single data stream may be simpler to distribute, for example if the content presentation signal is to be distributed over a network. It may furthermore allow for backwards compatibility for display devices designed for a single interleaved data stream.

According to a different feature of the invention, at least two of the plurality of content data streams have different data rates. Accordingly the invention preferably allows for different data rates of data streams thereby allowing for an increased degree of flexibility and adaptability wherein each data stream may have an associated data rate optimised for the signal represented by the content data stream.

According to a different feature of the invention, at least one of the plurality of content data streams is a non-interleaved content data stream. Accordingly, the invention allows for a simple organisation of each content data stream thereby facilitating the retrieval of specific desired data. A non-interleaved data stream specifically allows for a simple retrieval and decoding of that data stream by the apparatus.

According to a different feature of the invention, at least one of the plurality of content data streams is an elementary data stream. This allows for low complexity of the apparatus and facilitates the generation of the content presentation signal.

According to a different feature of the invention, at least one of the plurality of content data streams is an audiovisual signal. Hence, the invention provides for an improved apparatus for processing audiovisual signals. The audiovisual signal may for example be an audio signal, a video signal or a combined audio and video signal.

According to a different feature of the invention, the presentation criterion is a desired content presentation signal bandwidth characteristic. The desired content presentation signal bandwidth characteristic may specifically be the data rate of the content presentation signal. This enables that the retrieval of content data streams and the processing of the retrieved data to be particularly suited for an available bandwidth of the content presentation signal.

According to a different feature of the invention, the presentation criterion is a desired content presentation signal quality characteristic. This allows for the retrieval of content data streams and the processing of the retrieved data to be particularly suited for a desired quality of the content presentation signal.

According to a different feature of the invention, the presentation criterion is a bandwidth limitation related to the interface. The bandwidth restriction may be any bandwidth limitation associated with retrieving data from the content source through the interface. For example, if the content source is accessed through a communication link or data network, the bandwidth limitation may be a data rate of the communication link or the data network. If the content source is a DVD disc, the bandwidth limitation may be associated with a reading data rate of a DVD drive. This allows for selection of content data streams such that the combined data rate meets the bandwidth limitation. It may thus allow for a flexible and efficient system wherein the access of the content source is optimised to meet restrictions imposed by the apparatus.

According to a different feature of the invention, at least one of the plurality of content data streams is a single content type content data stream, and the apparatus further comprises means for generating a single content type presentation signal by retrieving the single content type content data stream. Specifically, the apparatus may be able to generate a single content type presentation signal without using the virtual content stream.

According to a different feature of the invention, the apparatus further comprises buffering means for buffering the virtual content stream. This facilitates the retrieval of data pointers and may reduce the frequency at which different data streams need to be accessed in the content source. Specifically for a DVD disc content source, this may reduce the required movement of the sledge carrying the optical pick up as fewer sledge jumps to the virtual content stream are required.

According to a different feature of the invention, the content source is a content signal storage medium. Accordingly the invention provides an improved apparatus for generating content presentation signals from content signal storage mediums. The content signal storage medium may for example be a magnetic disc, an optical disc or a magneto optical disc and more specifically may be a Compact Disc or a DVD disc.

According to a second aspect of the invention, there is provided a storage medium for a content signal comprising: a plurality of content data streams comprising content data associated with the content signal; and a virtual content stream comprising content data pointers to the content data of the plurality of content data streams; wherein the virtual content stream comprises synchronisation information related to the content data associated with the content data pointers.

According to a third aspect of the invention, there is provided a method for generating a content presentation signal from content data of a content source having a plurality of content data streams comprising content data associated with content signals and a virtual content stream comprising content data pointers to the content data of the plurality of content data streams; the method comprising the steps of: retrieving the virtual content stream through the interface; retrieving content data pointers from the virtual content stream in response to a presentation criterion; and generating the content presentation signal from content data of the plurality of content data streams associated with the retrieved content data pointers.

These and other aspects, features and advantages of the invention will be apparent from and elucidated with reference to the embodiment(s) described hereinafter.

An embodiment of the invention will be described, by way of example only, with reference to the drawings, in which

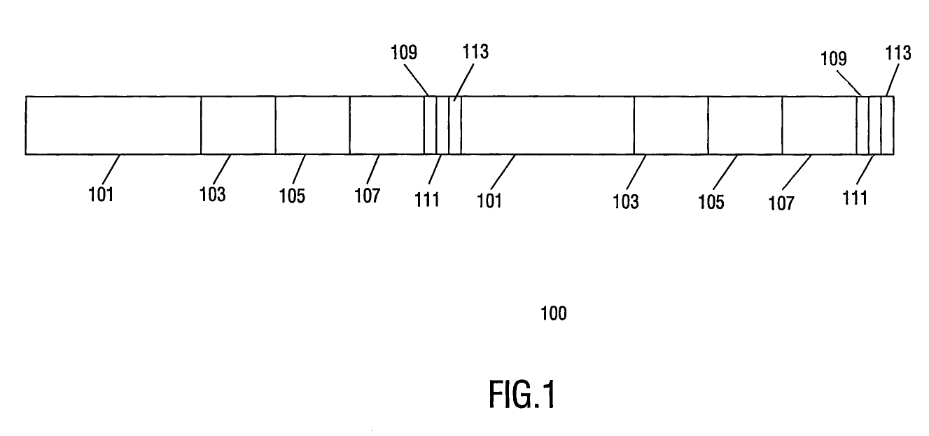

FIG. 1 is an illustration of a data arrangement of a content signal of a DVD in accordance with the prior art;

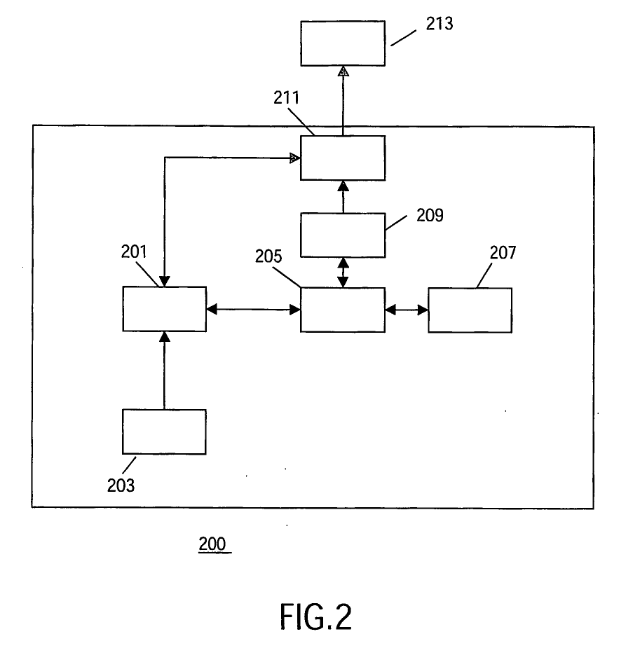

FIG. 2 illustrates a block diagram of an apparatus for generating a content presentation signal in accordance with an embodiment of the invention; and

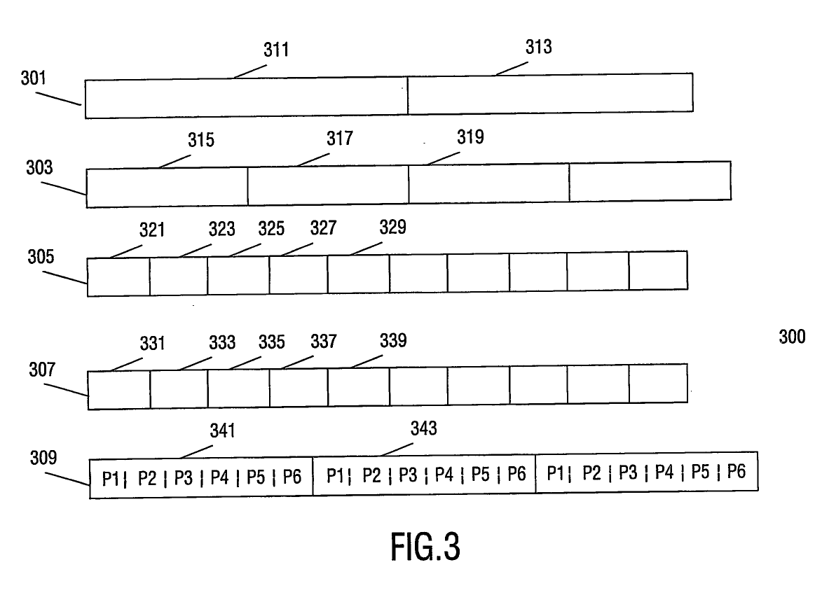

FIG. 3 illustrates a data arrangement for a content signal stored in a content source in accordance with an embodiment of the invention

The following description focuses on an embodiment of the invention applicable to a DVD disc and DVD presentation apparatus but it will be appreciated that the invention is equally applicable to many other content sources and apparatuses.

FIG. 1 is an illustration of a data arrangement of a content signal of a DVD in accordance with the prior art.

In a conventional DVD disc, the content signal to be presented, such as a film, comprises a plurality of content sub signals. Typically, a DVD comprises a video sub-signal, a plurality of audio sub-signals (e.g. corresponding to the soundtrack in different languages) and a plurality of subtitle data signals. The data associated with the different sub-signals are interleaved into a single data stream as illustrated in FIG. 1.

In the simplified example of FIG. 1, a data stream 100 comprises a first video data block 101, followed by three audio data blocks 103, 105, 107 corresponding to three different language versions of the soundtracks. The audio data blocks 103, 105, 107 are followed by three data blocks 109, 111, 113 which in the present example are subtitle blocks associated with different subtitle languages. The data blocks 109, 111, 113 are followed by the next segment of data wherein the arrangement is repeated for the next section of the film.

A conventional DVD player will generate an audiovisual signal by continuously and consecutively reading the data stream from the DVD. The DVD player subsequently selects the data of the desired language and subtitles and discards the data which is associated with sub-signals that are not selected. Accordingly, a single data stream having a predetermined data rate is read from the disc. This allows for very little flexibility in the composition of the data of the content signal stored on the DVD. For example, a significant overhead is incurred in that data which is not required or used in the generation of the presentation signal must be read by the DVD player. Furthermore, technological advances in the data rate at which data can be read from DVDs cannot be fully exploited as the data rate of the data stream is restricted by having to be compatible with legacy equipment that is not able to retrieve data at increased rates. Furthermore, a sequential interleaved arrangement of data requires that the DVD player is able to read data at the maximum combined data rate regardless of which quality is required.

FIG. 2 illustrates a block diagram of an apparatus for generating a content presentation signal in accordance with an embodiment of the invention. In particular, the apparatus 200 is an improved DVD player operable to generate the content presentation signal from a DVD having an improved data arrangement.

The apparatus 200 comprises a DVD drive 201 which is operable to read data from a content source 203 in the form of a DVD comprising data associated with a content signal. The DVD has a data arrangement in accordance with an embodiment of the invention. Specifically, the DVD comprises a plurality of content data streams comprising content data associated with the content signal and a virtual content stream comprising content data pointers to the content data of the plurality of content data streams.

The DVD drive 201 thus provides an interface to the content source 203 in the form of the DVD. The DVD drive 201 is coupled to a virtual content stream processor 205 which is operable to retrieve the virtual content stream from the DVD through the interface in the form of the DVD drive 201. The virtual content stream processor 205 is coupled to a memory 207 and in the preferred embodiment, the virtual content stream processor 205 buffers the virtual content stream by temporarily storing it in the memory 207. The virtual content stream processor 205 is coupled to a data pointer processor 209 which is operable to retrieve content data pointers from the virtual content stream in response to a presentation criterion. The data pointer processor 209 is fed the retrieved data pointers from the virtual content stream processor 205, for example by the data pointer processor 209 accessing the memory 209 through the virtual content stream processor 205. Specifically, the data pointer processor 209 may select a subset of data pointers which correspond to a given desired presentation characteristic or characteristics. For example, the data pointer processor 209 may select the subset of data pointers that correspond to the desired video quality, language and subtitle language for the content presentation signal.

The data pointer processor 209 is coupled to a presentation signal processor 211. The presentation signal processor 211 is operable to generate the content presentation signal from content data of the plurality of content data streams associated with the retrieved content data pointers. The presentation signal processor 211 is coupled to the DVD drive 201 and through this it retrieves the content data of the plurality of content data streams that are pointed to by the retrieved data pointers. The retrieved content data is combined in a suitable way to generate the content presentation signal.

The presentation signal processor 211 is furthermore connected to a presentation device, which in the preferred embodiment is an external display for audiovisual content, such as a TV or monitor.

In some embodiments, the virtual content stream processor 205 may retrieve the entire virtual content stream and store it in the memory 207. Typically the data content on the DVD is very high and may comprise content data streams of typically up to 9 GByte. However, in most applications the data content data streams have very different associated data rates and sizes. In a typical example the content data streams used for playback, comprises one large content data stream (video) and several smaller content data streams (audio, sub-titles). In the preferred embodiment, the virtual content stream and the smaller content data streams are read in their entirety and stored in memory whereas the main content data stream (such as the high quality video content data stream) is read directly from the input source (DVD drive). The stored content data streams are then combined with the main content data stream as it is read to generate the content presentation signal.

FIG. 3 illustrates a data arrangement for a content signal stored in a content source in accordance with an embodiment of the invention. Specifically, the content source is a DVD 300 suitable for the apparatus of FIG. 2, and the content signal is an audiovisual signal.

In the illustrated example, the DVD 300 comprises four content data streams each of which comprises content data associated with an underlying content signal. Specifically, a first video data stream 301 comprises a high data rate High Definition TV (HDTV) video signal. A second video data stream 303 comprises a lower data rate standard definition TV video signal. A third data stream 305 comprises content data associated with a first and second language soundtrack and a fourth data stream 307 comprises content data associated with a third and fourth language soundtrack.

The DVD 300 further comprises a virtual content stream 309 that comprises content data pointers. The data pointers point to data of the content data streams 301, 303, 305, 307. The virtual content stream 309 comprises synchronisation information related to the content data. Specifically, the data pointers of the virtual content stream 309 are grouped together such that the data pointers within a group relate to simultaneous data for the content presentation signal. Thus the data pointers in a group points to the HDTV data of the first data stream 301 related to a specific time point, the standard video data of the second data stream 303 related to the same time point, the first language data of the third data stream 305 related to the time point, the second language data of the third data stream 305 related to the time point, the third language data of the fourth data stream 307 related to the time point and the second language data of the third data stream 307 related to the time point.

In the embodiment described, the data of the plurality of content data streams are divided into data sections with each data section corresponding to a given time interval for the presentation signal. For example, the data may be divided into sections of a duration of 20 seconds of the underlying content signal. Hence, the first data stream is shown having a first data section 311 comprising 20 seconds of HDTV data followed by a section of 20 seconds of HDTV data associated with the following 20 seconds of the content signal. Likewise the second data stream is divided into data sections 315, 317, 319 of 20 seconds duration. As the data rate is lower for the standard definition video signal, the data sections are smaller than for the first data stream 301. Similarly, the third and fourth content data streams 305, 307 comprise data sections 321, 323, 325, 327, 329, 331, 333, 335, 337, 339 of 20 seconds duration. In the shown example, data sections 311, 315, 321, 323, 331 and 333 correspond to the same 20 seconds of the content presentation signal and data sections 313, 317, 325, 327, 335 and 337 correspond to the following 20 seconds of the content presentation signal.

The data pointers of the virtual content stream are grouped together according to the data sections of the content data streams 301, 303, 305, 307. Specifically, a first data section 341 comprises six pointers P1 to P6 pointing to the data sections associated with the a specific time point, and a second data section 343 following the first data section 341 associated with a time point 20 seconds later. Thus, in the first data section 341, P1 may point to data section 311, P2 to section 315, P3 to section 321, P4 to section 323, P5 to section 331 and P6 to section 333. In the second data section 343, P1 may point to data section 313, P2 to section 317, P3 to section 325, P4 to section 327, P5 to section 335 and P6 to section 337.

Hence, in the illustrated embodiment, the content data streams have different data rates according to the natural data rate required for that signal. For example, the HDTV data of a 20 second section may be e.g. a hundred times larger than that of a data section of content data streams 305, 307 of the soundtrack. In some embodiments, the data sections may have different associated time intervals depending on the data rate. For example, a data section of a HDTV content data stream may correspond to a time interval of 5 seconds and a data section of an audio content data stream may correspond to a time interval of 20 seconds.

In the embodiment, as illustrated in the example of FIG. 3, one or more of the content data streams is a non-interleaved content data stream and/or an elementary data stream. In such an embodiment, the individual data streams may be optimised for the characteristics of the individual content sub-signal associated with that content data stream, and the processing required for generating a content presentation signal may be simplified.

It will be appreciated that in other embodiments, the pointers in the virtual content steam may not split the data on the basis of time, but rather on the basis of for example data size. Specifically, in conventional DVD standards (and other optical disc standards), there is generally additional multiplex information added at the start of each sector. In accordance with an embodiment of the invention, this multiplex information may be alternatively or additionally be included in the virtual content stream thereby allowing both the flexibility of different data rates and also allowing the same data to be present in several different virtual streams. Thus in some embodiments the virtual content stream comprises a pointer for every fixed size block of data whereas in other embodiments, the virtual content stream may alternatively or additionally comprise pointers related to fixed presentation times and thus to data blocks of varying size.

In the following, an example of the operation of the apparatus of FIG. 2 with a content source in the form of the DVD of FIG. 3 will be described.

Initially, the virtual content stream processor 205 retrieves the whole virtual content stream 309 through the DVD drive 201 and stores it in the memory 207.

The data pointer processor 209 determines a presentation criterion for selecting data pointers. The presentation criterion is determined in response to a characteristic that may influence a parameter or characteristic of the content presentation signal. In the preferred embodiment, the presentation criterion is a bandwidth limitation related to the interface to the content source 203, and specifically it is determined in response to a transfer data rate or reading rate of the DVD drive 201. For example, in older equipment, the data rate that can be achieved from the DVD drive 201 may be insufficient to support the data rate required for HDTV signals but sufficient to support the standard video quality. Hence, the presentation criterion may comprise a criterion that a content presentation signal based on a standard video quality is to be generated. Specifically, the presentation criterion may be predetermined and the data pointer processor 209 may select data pointers without specifically determining a presentation criterion.

Preferably, the presentation criterion is furthermore determined in response to preferences of a user. For example, the user may select a preferred language soundtrack, and the presentation criterion will be set such that this language soundtrack is included in the content presentation signal.

Furthermore, the presentation criterion may be set according to a desired presentation signal bandwidth characteristic and/or a desired presentation signal quality characteristic. For example, in some cases the bandwidth across the connection from the presentation signal processor 211 to the presentation device 211 may be limited, and the presentation criterion may be set such that a content presentation signal is generated that can be communicated over this communication link. For example, if a network or presentation device is used that cannot support HDTV, the presentation criterion will be set to generate a content presentation signal based on the standard definition video quality. Likewise, if a lower presentation quality than HDTV is acceptable, the presentation criterion may be set to generate a content presentation signal based on the standard definition video quality. Although the DVD drive 201 in these embodiments may be able to support the higher data rate data streams, the presentation criterion is selected such that lower rate content data streams are used. This may free up resources for retrieving other data from the DVD, or may free up computational resource in the apparatus for other purposes.

Thus, in the preferred embodiment, the presentation criterion simply comprises in a selection indication indicating which content data streams should be used for generating the content presentation signal. The data pointer processor 209 consequently proceeds to retrieve the corresponding pointers from the memory 207 through the virtual content stream processor 205. As a specific example, if standard definition video quality and language two is selected in accordance with the current presentation criterion, the pointers P2 and P4 for all sections are retrieved from the memory.

The retrieved pointers are fed to the presentation signal processor 211. The presentation signal processor 211 proceeds to generate the content presentation signal by sequentially processing the pointers and retrieving the content data of the content data streams pointed to by the selected data pointers. Thus, in the specific example, the presentation signal processor 211 first reads the data pointers P2 and P4 from the first section 341 of the virtual content stream 309. In response, it accesses the DVD drive 201 to retrieve the content data of data section 315 and 323. It then proceeds to generate the content presentation signal for a 20 second interval based on this data. Subsequently, the presentation signal processor 211 reads the data pointers P2 and P4 from the second section 343 of the virtual content stream 309. In response, it accesses the DVD drive 201 to retrieve the content data of data section 317 and 327. It then proceeds to generate the content presentation signal for the following 20 second interval based on this data.

Specifically, the presentation signal processor 211 may generate the content presentation signal as an interleaved content data stream. Thus, it may generate a content presentation signal by creating a data stream where the retrieved data sections are merged into the same data stream. Thus, in the specific example, the content presentation signal may be generated as a data stream comprising data section 315 followed by data section 323 followed by data section 317 followed by data section 325 etc.

It will be clear to the person skilled in the art that the DVD data arrangement and system for generating a content presentation signal described allows for a significantly increased flexibility and possibility of increased performance, possibilities and quality. Specifically, the system allows for different content data streams having different data rates to be used in a flexible way.

It will be appreciated that the current description for clarity and brevity has focussed on a content source being a DVD. However, any suitable content source and interface may be used without detracting from the invention. For example, a remote content source storage may be accessed through an interface in the form of a communication link or data network.

It will also be appreciated that the described data arrangement and association between data pointers and content data is just one example, and that many other arrangements may be equally applicable. For example, a data pointer may point to a plurality of data sections in the same or different content data streams and a plurality of data pointers may be associated with the same content data etc.

In a preferred embodiment, one (or more) of the content data streams comprise interleaved content data associated with a plurality of content sub-signals and sufficient for generation of a content presentation signal. Specifically, the content source may in addition to the virtual content stream comprise one content data stream that comprises interleaved data in accordance with a conventional content data arrangement. This will allow for apparatuses to optionally generate a content presentation signal based on the virtual content stream or on the interleaved content data stream. Specifically, for a DVD embodiment, the interleaved content data stream may be a conventionally encoded DVD signal thereby allowing the DVD to be used in both DVD players operable to access the virtual content stream, as well as in conventional DVD players which do not comprise functionality for accessing the virtual content stream.

The invention can be implemented in any suitable form including hardware, software, firmware or any combination of these. However, preferably, the invention is implemented as software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

In summary, the invention relates to a system for generating a content presentation signal such as an audiovisual signal. A content source (203), such as a Digital Versatile Disc (DVD) comprises a plurality of content data streams (301, 303, 305, 307). The content source (201) further comprises a virtual content stream (309) comprising content data pointers to the content data of the plurality of content data streams (301, 303, 305, 307). An apparatus (200) comprises an interface for the content source and a virtual content stream processor (205) which retrieves the virtual content stream (309) through the interface (201) and stores it in memory (207). A data pointer processor (209) selects data pointers in response to a presentation criterion, such as a desired quality or data bandwidth of the interface (201). A presentation signal processor (211) generates a content presentation signal by retrieving the content data of the plurality of content data streams pointed to by the content data pointers.

1. An apparatus (200) for generating a content presentation signal comprising: an interface (201) for a content source (203), the content source (203) comprising a plurality of content data streams (301, 303, 305, 307) comprising content data associated with a content signal and a virtual content stream (309) comprising content data pointers to the content data of the plurality of content data streams (301, 303, 305, 307);
means (205) for retrieving the virtual content stream (309) through the interface (201);
means (209) for retrieving content data pointers from the virtual content stream (309) in response to a presentation criterion; and
means (211) for generating the content presentation signal from content data of the plurality of content data streams (301, 303, 305, 307) associated with the retrieved content data pointers.

2. An apparatus as claimed in claim 1 wherein the virtual content stream (309) comprises synchronisation information related to the content data associated with the content data pointers, and the means (211) for generating the content presentation signal is operable to generate the content presentation signal in response to the synchronisation information.

3. An apparatus as claimed in claim 1 wherein the means (211) for generating is operable to generate the content presentation signal from a subset of content data streams.

4. An apparatus as claimed in claim 1 wherein the means (211) for generating is operable to generate the content presentation signal as an interleaved content data stream by interleaving the content data of the plurality of content data streams (301, 303, 305, 307) associated with the retrieved content data pointers

5. An apparatus as claimed in claim 1 wherein at least two of the plurality of content data streams (301, 303, 305, 307) have different data rates

6. An apparatus as claimed in claim 1 wherein at least one of the plurality of content data streams (301, 303, 305, 307) is a non-interleaved content data stream.

7. An apparatus as claimed in claim 1 wherein at least one of the plurality of content data streams (301, 303, 305, 307) is an elementary data stream.

8. An apparatus as claimed in claim 1 wherein at least one of the plurality of content data streams (301, 303, 305, 307) is an audiovisual signal.

9. An apparatus as claimed in claim 1 wherein the presentation criterion is a desired content presentation signal bandwidth characteristic.

10. An apparatus as claimed in claim 1 wherein the presentation criterion is a desired content presentation signal quality characteristic.

11. An apparatus as claimed in claim 1 wherein the presentation criterion is a bandwidth limitation related to the interface (201).

12. An apparatus as claimed in claim 1 wherein at least one of the plurality of content data streams (301, 303, 305, 307) is a single content type content data stream, and the apparatus further comprises means for generating a single content type presentation signal by retrieving the single content type content data stream.

13. An apparatus as claimed in claim 1 wherein further comprising buffering means (207) for buffering the virtual content stream.

14. An apparatus as claimed in claim 1 wherein the content source (203) is a content signal storage medium

15. A storage medium (300) for a content signal comprising:
a plurality of content data streams (301, 303, 305, 307) comprising content data associated with the content signal; and
a virtual content stream (309) comprising content data pointers to the content data of the plurality of content data streams;
wherein the virtual content stream comprises synchronisation information related to the content data associated with the content data pointers.

16. A storage medium as claimed in claim 15 wherein at least one of the plurality of content data streams (301, 303, 305, 307) comprises interleaved content data associated with a plurality of content sub-signals and sufficient for generation of the content presentation signal

17. A method for generating a content presentation signal from content data of a content source (203) having a plurality of content data streams (301, 303, 305, 307) comprising content data associated with a content signal and a virtual content stream (309) comprising content data pointers to the content data of the plurality of content data streams (301, 303, 305, 307); the method comprising the steps of:
retrieving the virtual content stream through the interface (201);
retrieving content data pointers from the virtual content stream (309) in response to a presentation criterion; and
generating the content presentation signal from content data of the plurality of content data streams (301, 303, 305, 307) associated with the retrieved content data pointers.

18. A computer program enabling the carrying out of a method according to claim 17.

19. A record carrier comprising a computer program as claimed in claim 18.
